(19) United States
(12) Patent Application Publication
(10) Pub. No.: US 2012/0054166 A1
(43) Pub. Date: Mar. 1, 2012

(54) System for displaying search engine results with images

(76) Inventor: Leo Jeremias, Los Angeles, CA (US)

(21) Appl. No.: 12/807,201

(22) Filed: Aug. 31, 2010

(51) Int. Cl. G06F 17/30

(52) U.S. Cl. 707/706; 707/E17.108

(57) ABSTRACT

A search engine system for augmenting the display of search engine results. A user uses a browser to identify a search engine. A script associated with the browser obtains layout information for the search engine. The user submits a query to the layout. The browser submits the query to a master server. The master server retrieves search results responsive to the query and low-resolution images associated therewith. The master server returns the search results and images to the browser, which displays the results to the user. The browser may obtain high-resolution images, scaled from low-resolution images in response to a request from the user. The master server may also provide search engine results from other search engines, augmenting the display to accommodate this additional real-time information.

### TECHNICAL FIELD

This invention relates in general to search engines, and, more particularly, to a system for augmenting the display of a search engine results webpage with real-time information such as additional search results and screenshot images.

### BACKGROUND

Network information retrieval systems, such as search engines are well known in the art. Different search engines offer different user interfaces. Over time, search engine users become accustomed to specific user interfaces associated with specific search engines. While new search engines with new features are constantly being developed, it is difficult to convince a user to switch from a known search engine interface to a new interface. Even if the features offered by a new search engine would be preferable to a user, the user may elect to stay with the less desirable search engine, simply because of the user's familiarity with a particular search engine interface. It would, therefore, be desirable to provide a search engine with additional features, while maintaining a search engine interface familiar to existing users.

Search engines develop algorithms for matching search results as precisely as possible with the intent of a searcher's query. These algorithms allow the search engines to return more accurate results in an increasingly timelier manner. Aggressive marketers, both legitimate and illegitimate, aware of these algorithms, optimize their websites to push the websites higher than they would otherwise appear in the hierarchy of search results as determined by the search engine's algorithm. While many search engine users recognize such websites as undesirable once the users actually see the websites, actually visiting the website wastes time and resources. Additionally, if the marketer's advertising revenue is based upon page views, simply having a user visit the website is sufficient to generate income from the user, even if the user immediately leaves the website and returns to the search engine website.

In an effort to address this problem, some search engines associate tiny “thumbnail” images with the search results to allow users to “see” the websites before wasting time visiting them. Knowing this, savvy marketers modify the look of their websites to have them appear, when viewed in thumbnail format, to have the information desired by the users. Because thumbnail images are typically too small to make out much specific detail about a particular website, marketers are again able to fool users into visiting undesirable websites. It is not until the users visit the disguised website that the deception is discovered. Again, by this time, the marketer has been compensated and the user's time has been wasted. It would, therefore, be desirable to provide users with the ability to accurately preview a website screenshot along with the search results before actually visiting the website.

An additional drawback associated with the prior art, is that search engines typically cache images of websites. The search engines produce these cached images, rather than real-time images of the websites, to increase the speed with which search results are produced. While caching images can reduce the time associated with compiling a set of search results, the value of such images, especially for constantly changing websites, can be significantly diminished. It would, therefore, be desirable to produce images in response to a search engine query that reflect real-time images of the websites identified in the search engine results.

Prior art search engines typically cache images in a low-resolution format. While storing images in a low-resolution format facilitates the efficiency with which the search engines can deliver images to users, the low-resolution format makes it difficult for users to accurately identify detailed information in the images. While it would be desirable to deliver higher resolution images to users, higher resolution images not only require a significantly greater amount of storage and bandwidth, but providing higher resolution images in a large format reduces the number of images which can be simultaneously displayed on a user's monitor. It would therefore be desirable to provide users access to a large number of high-resolution images in response to a search engine query.

Search engines each have their own search algorithms. While search engine creators pride themselves on the quality of their algorithms, no algorithm is perfect. For some search engine queries, one search engine algorithm returns better results, for other search engine queries, another algorithm returns better results. Even if the search query is known, it may not be immediately apparent which search engine algorithm will return the best results.

Compounding the problem is the trade secret nature of search engine algorithms. While the general aspects of search engine algorithms can be determined from examining various search engine results, the exact parameters of the search engine algorithms are generally known only to a handful of people within the associated organization. Therefore, while it would be desirable to combine the best search engine algorithms to return the best results, no single entity has direct access to all of these algorithms. To address this problem, metasearch engines are used to query multiple search engines and display the results either as a single list, or sorted according to their associated search engines.

Although metasearch engines address the problem of one search engine algorithm having an advantage over another search engine algorithm, metasearch engines still require a user to actually visit a website identified in the search engine to determine if the content provided on the webpage is sufficiently relevant. As prior art metasearch engines operate from the metasearch engine server side, a request for an accurate, real-time screenshot of a website associated with one of the search results would take an undesirably long time to process. It would, therefore, be desirable to provide users with the benefit of quickly previewing real-time images of the webpages associated with a search engine of multiple search engines.

Another drawback to prior art search engines is the difficulty in sorting search results. While search engines are designed to return search results in order of relevance, the final arbiter of relevance is the user. Returning search engine results in the form of website names and uniform resource locators (URLs) makes it difficult for users to readily assess the relevance of particular search results. Even associating brief excerpts of text and thumbnail images from the individual websites, along with the names and URLs, does not eliminate the difficulty in quickly and accurately determining the most relevant websites from the search results. While it would be desirable to see all of the actual websites simultaneously, most monitors lack sufficient display area to simultaneously display all of the webpages simultaneously. Additionally, as prior art search engines operate from the search engine server side, displaying all of the webpages simultaneously would take an undesirably long amount of time to request, produce and display, as compared to the time required to return the search results themselves. It would, therefore, be desirable to provide users with a system for previewing large screenshots of the websites associated with the search engine results. The difficulties encountered in the prior art discussed hereinabove are substantially eliminated by the present invention.

### SUMMARY OF THE DISCLOSED SUBJECT MATTER

A user uses a web browser on a computer to send a search request to a search engine server. A first script associated with the browser retrieves search results responsive to the query. A second script retrieves the graphical user interface associated with the search engine. A third script retrieves real-time information, such as screenshots or search results from another search engine. The browser renders a webpage on a monitor associated with the user's computer. The webpage incorporates the graphical user interface layout associated with the search engine and the search results augmented with the real-time information. The real-time information can be additional search results retrieved from another search engine. Since the system uses the layout associated with the user's preferred search engine, the user is easily able to navigate the website.

The browser may be provided with additional scripts to augment the website with additional real-time information, such as low-resolution screenshot images associated with the search results. If the user clicks on one of the low-resolution images, another script may be employed to retrieve a high-resolution real-time version of the image. Similarly, a script may be employed to retrieve a plurality of high-resolution images and present them in a slideshow format. Scripts associated with the browser may access application programming interfaces, to retrieve additional real-time information and create mash-ups combining real-time information from multiple sources.

### BRIEF DESCRIPTION OF THE DRAWINGS

The present invention will now be described, by way of example, with reference to the accompanying drawings in which:

FIG. 1 illustrates a generalized system architecture for the metasearch engine;

FIG. 2 illustrates a webpage displayed by the browser showing search results obtained from the metasearch engine;

FIG. 3 illustrates the webpage of FIG. 2, shown with an expanded real-time image of one of the thumbnail screenshot images;

FIG. 4 illustrates the webpage of FIG. 2 shown displaying search results from a single search engine server;

FIG. 5 illustrates a fast preview webpage of the present invention;

FIG. 6 illustrates a search engine webpage;

FIG. 7 illustrates a search engine webpage populated with search engine results; and

FIG. 8 illustrates an additional fast preview webpage of the present invention.

### DETAILED DESCRIPTION OF THE DRAWINGS

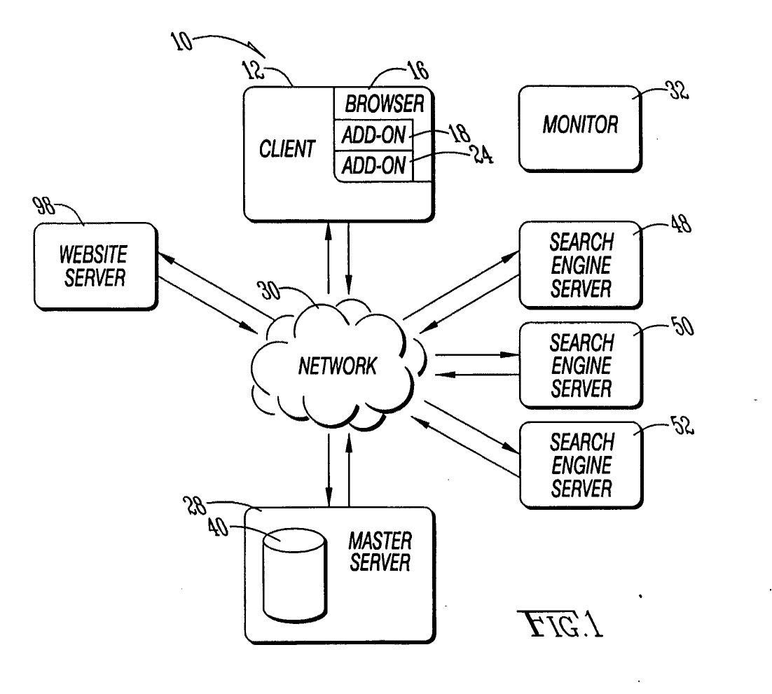

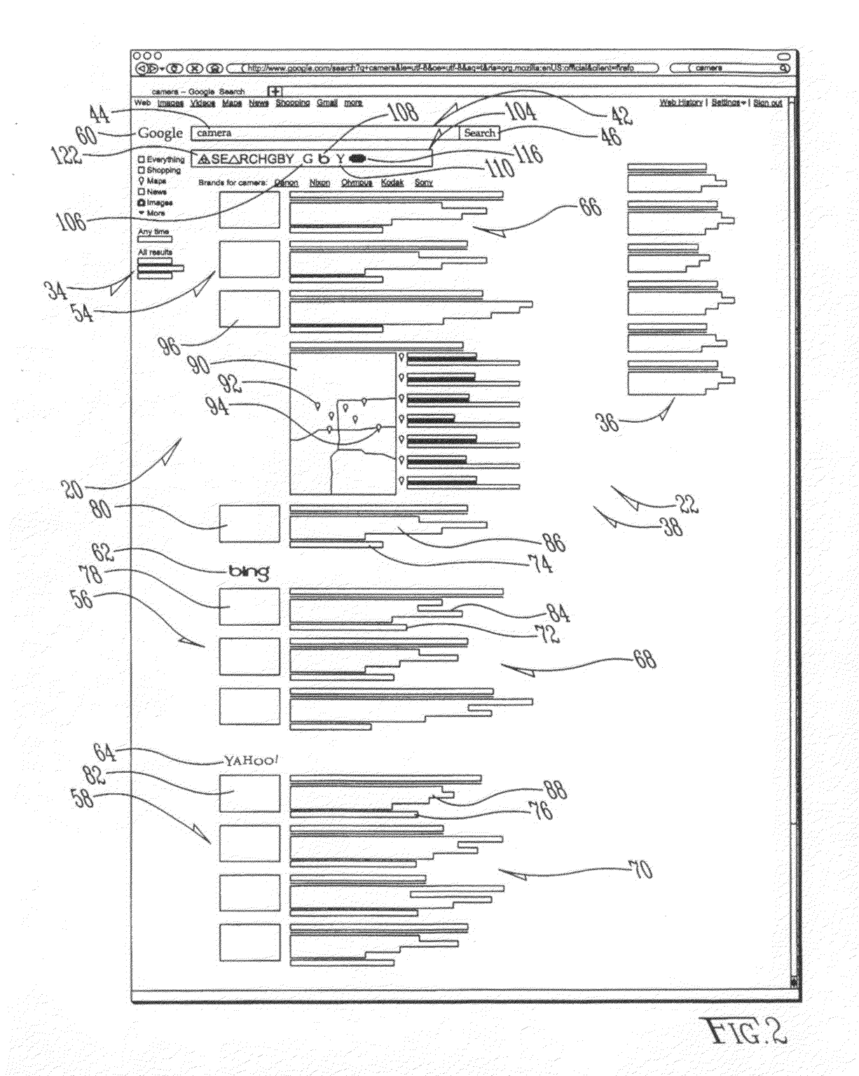

With reference to the drawings, a general system architecture according to the present invention is shown generally as (10) in FIG. 1. In this system architecture (10), there is a computing device, such as a client device (12). The client device (12) may be any type known in the art, including, but not limited to, a desktop, workstation, notebook, netbook, tablet, mainframe, terminal, or any device having the capability of communicating over a network (14). In the preferred embodiment, the client device (12) is provided with network access applications, such as those known in the art, necessary to communicate over the network (14). The network (14) may be any type known in the art, including, but not limited to, the Internet, a local area network (LAN), a wide area network (WAN), telephony or any combination thereof.

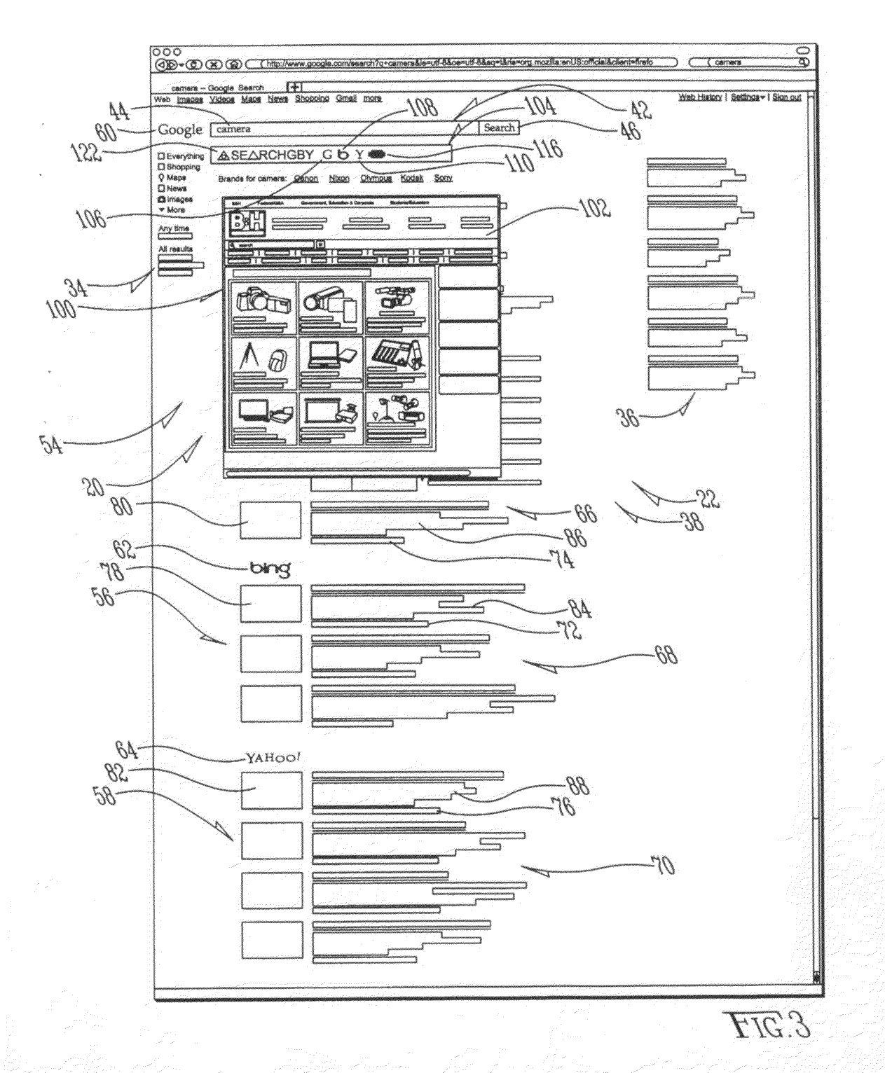

A browser (16), is provided and configured to execute computer executable instructions, that when executed by the computing device cause the browser (16) to perform the method detailed more fully below. The browser (16) is preferably Firefox, distributed by Mozilla under a creative commons license, but may be Chrome, Internet Explorer, Safari, or any suitable browser known in the art. The browser (16) is provided with an add-on (18), such as the Greasemonkey add-on, or other add-on, which uses small pieces of script, such as JavaScript, to customize the way the browser (16) retrieves and displays information (20) on a webpage (22). The browser (16) is also provided with a supplemental add-on (24), which includes another script that works with Greasemonkey to display a search results (26) in a manner such as that shown in FIG. 2.

A user types in a uniform resource locator (URL) website address for a search engine, or otherwise identifies a search engine to the browser (16). Typing in the search engine URL causes a script associated with the browser (16) to obtain information sufficient to allow the browser to display the search engine webpage (22) shown in FIG. 2. The script associated with the browser (16) obtains the website information to present on a display associated with the client device (12), such as a monitor (32). The script obtains the information from a master server (28) across a network such as the Internet (30). The master server (28) is provided with software configured to execute computer executable instructions, to return website layout information and real-time information, such as search results and images to the client device (12) across the Internet (30) via the script associated with the browser (16). Website layout information, such as information associated with the navigation bar (34), advertisements (36) and the general layout (38) of the webpage (22) may be obtained directly from the search engine server (48) associated with the preferred search engine. Alternatively, the website layout information may be cached in a repository such as a database (40) associated with the master server (28).

The webpage (22) includes a search field (42) into which a user inputs a search query (44), such as “camera.” The user selects the search button (46), which uses known Internet protocols to cause a script associated with the browser (16) to transmit the search query (44) across the Internet (30) to the master server (28). The master server (28) uses the application programming interfaces (API) of multiple search engine servers (48), (50) and (52), to obtain search results to the search query (44). Alternatively, the script may query all of the search engine servers (48), (50) and (52), directly to obtain search results to the search query (44).

The search engine servers (48), (50) and (52) each use a unique, predetermined algorithm to produce search results for a given query. The search engine servers (48), (50) and (52) may be of any type known in the art. In the preferred embodiment, the search engine servers are a Google® search engine server (48), a Bing® search engine server (50) and a Yahoo® search engine server (52). The first search engine server (48) API returns a first set of search results to the master server (28). The second search engine server (50) API returns a second set of search results to the master server (28). The third search engine server (52) API returns a third set of search results to the master server (28).

The search results include, in descending order of relevance, website addresses, which include Uniform Resource Locators (URLs), and a small excerpt of text from a webpage of the websites associated with the search results. The search results may also include a thumbnail image from a webpage of the websites associated with the search results. Preferably, the master server (28) uses the search results to access webpages of the websites associated with the search results to capture, retrieve and cache screenshot images of the webpages. The images may be cached at any desired resolution. The images are preferably cached at a resolution no greater than five megapixels, more preferably no greater than one megapixel and most preferably, no greater than ninety thousand pixels. Before sending them to the client device (12), the master server (28) compresses the images to a low-resolution, sometimes called a “thumbnail,” preferably no greater than ninety thousand pixels and more preferably, no greater than 10,000 pixels. If desired, the images may be compressed even further for specific applications, such as for use on mobile devices. Alternatively, the master server (28) may provide uncompressed images to the client device (12) for further compression or processing by a script associated with the browser (16).

The master server (28) filters the search results to remove duplicate results. The master server (28) removes all results from the second set of search results that are also included in the first set of search results to produce a first filtered set of search results. The master server (28) removes all results from the third set of search results which are also included in the first set of search results or the second set of search results to produce a second filtered set of search results. The first set of search results, the first filtered set of search results and the second filtered set of search results collectively comprise a super-set of unique website addresses associated with the first set of search results, the second set of search results and the third set of search results. The master server (28) returns the resulting super-combined set of search results (the super-set of unique website addresses, text and screenshot images) to the client device (12). Alternatively, the master server (28) may return all of the search results to the client device (12) and allow the user to filter search results as desired with the browser (16).

The add-ons (18) and (24) associated with the browser (16) of the client device (12) display the super-combined set of search results on the monitor (32) in the form of the webpage (22). As shown in FIG. 2, the add-ons (18) and (24) divide the search results into a first grouping (54), a second grouping (56) and a third grouping (58) and display the search results associated with each grouping (54), (56) and (58). The add-ons (18) and (24) also display search engine identifiers (60), (62) and (64) identifying the particular search engine server (48), (50) or (52) associated with each grouping (54), (56) and (58).

The search results (66), (68) and (70) associated with each grouping (54), (56) and (58) are displayed in descending order of relevance. Depending upon the particular search engine servers (48), (50) or (52) and associated search algorithms used, the resulting webpage (22) may include a website address (72) in the second grouping (56) which has a higher relevance than a website address (74) in the first grouping (54). Similarly, the webpage (22) may include a website address (76) in the third grouping (58) which has a higher relevance than both the website address (72) in the second grouping (56) and the website address (74) in the first grouping (56).

The add-ons (18) and (24) associated with the browser (16) of the client device (12) also display thumbnail screenshot images (78), (80) and (82) and text excerpts (84), (86) and (88) adjacent their associated website addresses (74), (76) and (78). If desired, additional information retrieved from the search engine servers (48), (50) and (52), other websites, databases or elsewhere may be displayed along with the search results (66), (68) and (70). As an example, a map (90), including location pins (92) and (94) obtained from the search engine server in response to the search query (44) may be displayed on the webpage (22).

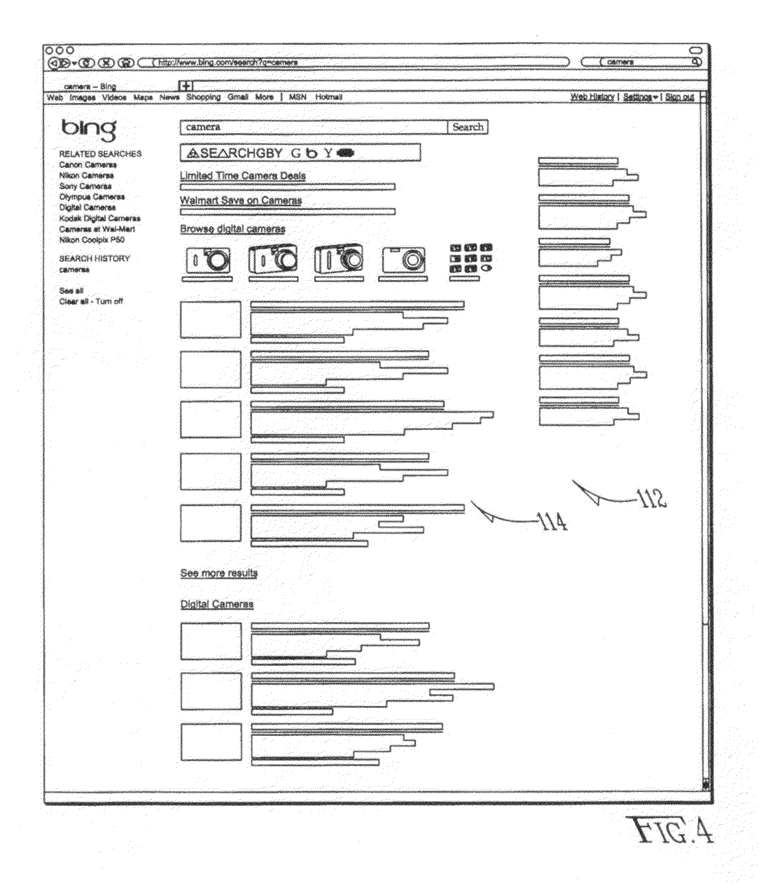

As shown in FIGS. 1-3, when a user clicks on one of the thumbnail screenshot images (96), the add-ons (18) and (24) associated with the browser (16) access, via the Internet (30), the master server (28). The master server (28) uses one or more scaling algorithms, such as bilinear interpolation, to produce a high-resolution version of the image. Preferably, the high-resolution of the image contains at least twice, more preferably at least ten times, and most preferably at least one hundred times the number of pixels as the low-resolution thumbnail screenshot images (96). Alternatively, the browser (16) may be provided with a script capable of directly scaling the low-resolution thumbnail screenshot images (96) from the client device (12). Preferably, the browser displays more than two, more preferably more than five, and most preferably more than seven low-resolution thumbnail screenshot images (96) on the webpage (22) at one time. Preferably, the browser displays less than seven, more preferably less than five, and most preferably one high-resolution image (100) on the webpage (22) at one time. Because low-resolution thumbnail screenshot images (96) contain so little information, the master server (28) is capable of collecting, storing and forwarding many such images at once. Because high-resolution screenshot images (100) contain relatively more information, it is desirable to collect, store and forward no more than four such high-resolution images (100) at one time.

Once the user clicks the thumbnail screenshot image (96), the add-ons (18) and (24) associated with the browser (16) cause the master server (28) to scale the low-resolution thumbnail screenshot image (96) selected by the user to a high-resolution image (100) of the associated webpage (102). The add-ons (18) and (24) display the larger image (100) of the associated webpage (102) over the thumbnail screenshot image (96). The add-ons (18) and (24) may retrieve several high-resolution images (100) in this manner as they are selected by the user. Preferably, no more than four high-resolution images (100) are requested by the user, retrieved or displayed at one time. The browser (16) may be provided with a script to scale the low-resolution thumbnail screenshot image (96) to a high-resolution image (100) directly on the client device (12). Alternatively, the browser (16) may be provided with a script to obtain a high-resolution image (100) across the Internet (30) directly from the associated website.

Preferably the low-resolution thumbnail screenshot images (96) and high-resolution image (100) are all generated in real-time.

Scaling the low-resolution thumbnail screenshot images (96) rather than retrieving, caching and transferring identical low-resolution and high-resolution images allows several real-time low-resolution images (96) and at least one high-resolution image (100) to be retrieved and displayed by the browser (16) quicker than if the request for high-resolution images and low-resolution images had been made directly to every website associated with the search results. The advantage of high-resolution images is that they can be displayed by the browser (16) in a larger format, providing the user with the opportunity to better assess whether the associated webpage (102) meets the user's needs. The process may be repeated with all of the thumbnail images until the user locates the desired webpage.

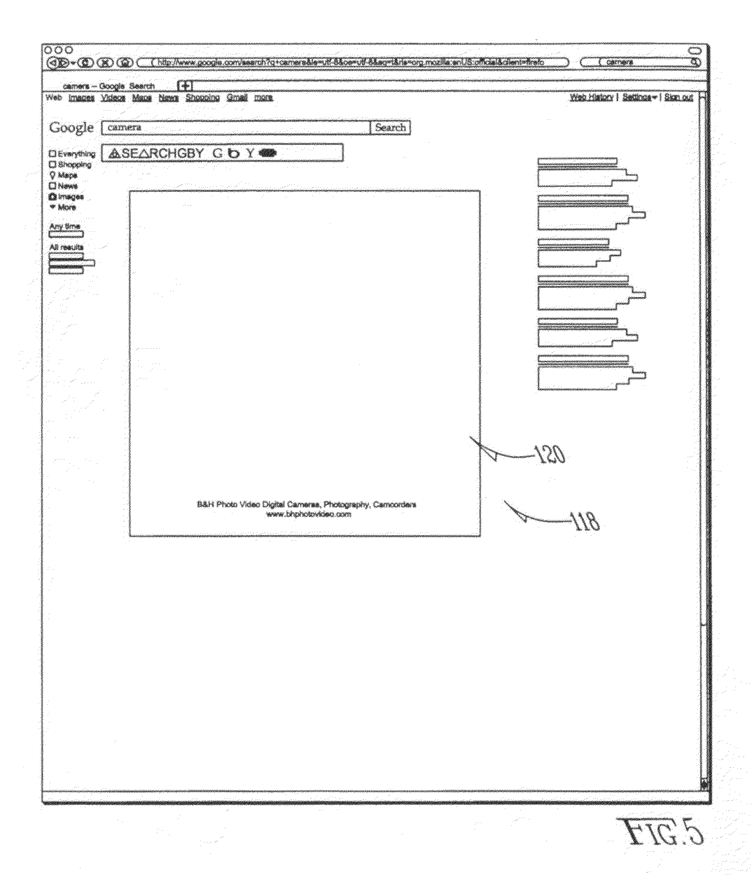

As shown in FIG. 2, the add-ons (18) and (24) also display a toolbar (104) on the search engine results webpage (22). (FIGS. 1-4). The toolbar includes buttons (106), (108) and (110) associated with each of the search engine servers (48), (50) and (52). Clicking any of these buttons (106), (108) or (110) activates the browser (16) to access the associated search engine server (48), and return the associated search engine webpage (112), displaying only those search results (114) associated with the search engine server (48).

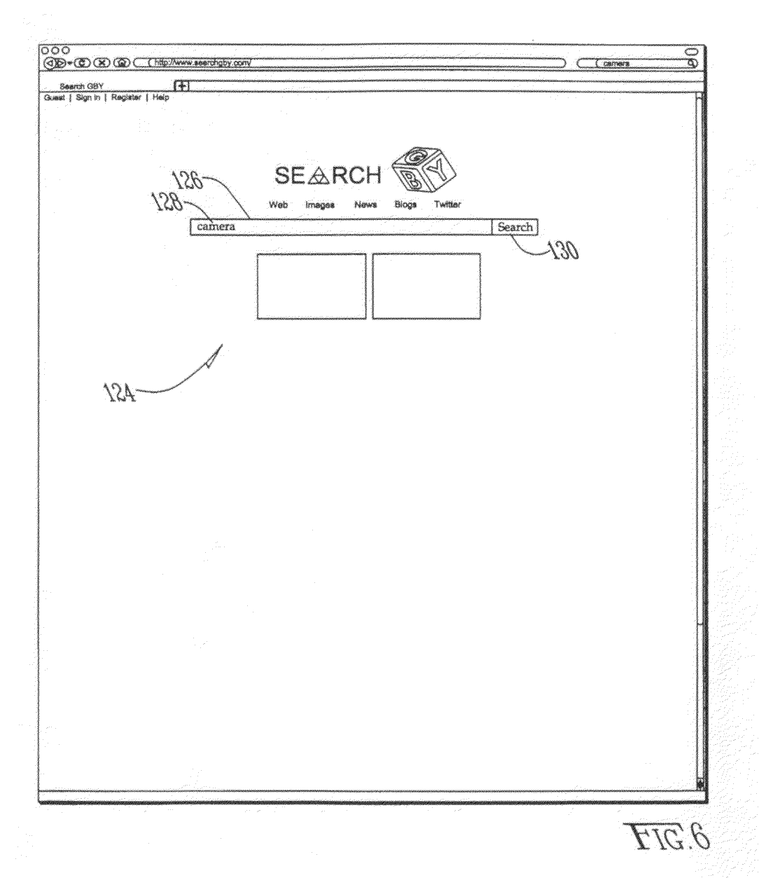

The toolbar (104) also includes a fast preview button (116). Clicking the fast preview button (116) activates the browser (16) to generate a webpage (118) displaying large images (120) associated with the search results (66), (68) and (70). (FIGS. 1-5). Preferably, the large images (120) are displayed without the thumbnail screenshot images (78), (80) and (82), text excerpts (84), (86) and (88) or website addresses (74), (76) and (78). Instead, each large image (120) is hyperlinked to its associated webpage. The add-ons (18) and (24) associated with the browser (16) access, via the Internet (30), the respective servers (98) indicated by the website address identified in the search results, to obtain the larger images (120) of the associated webpages (102). Generating the image requests from the client device (12) and accessing the servers (98) directly, rather than going through the master server (28), allows the larger images (120) to be returned and displayed quicker than if the requests had been made through the master server (28) and search engine server (48).

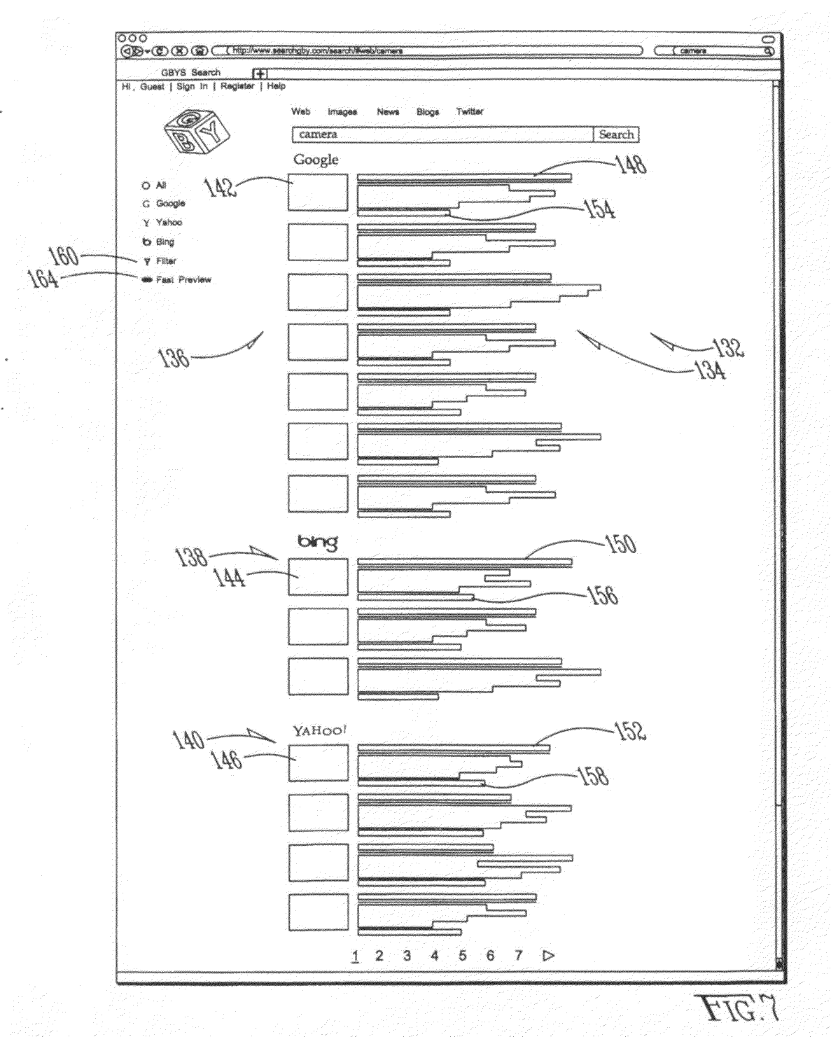

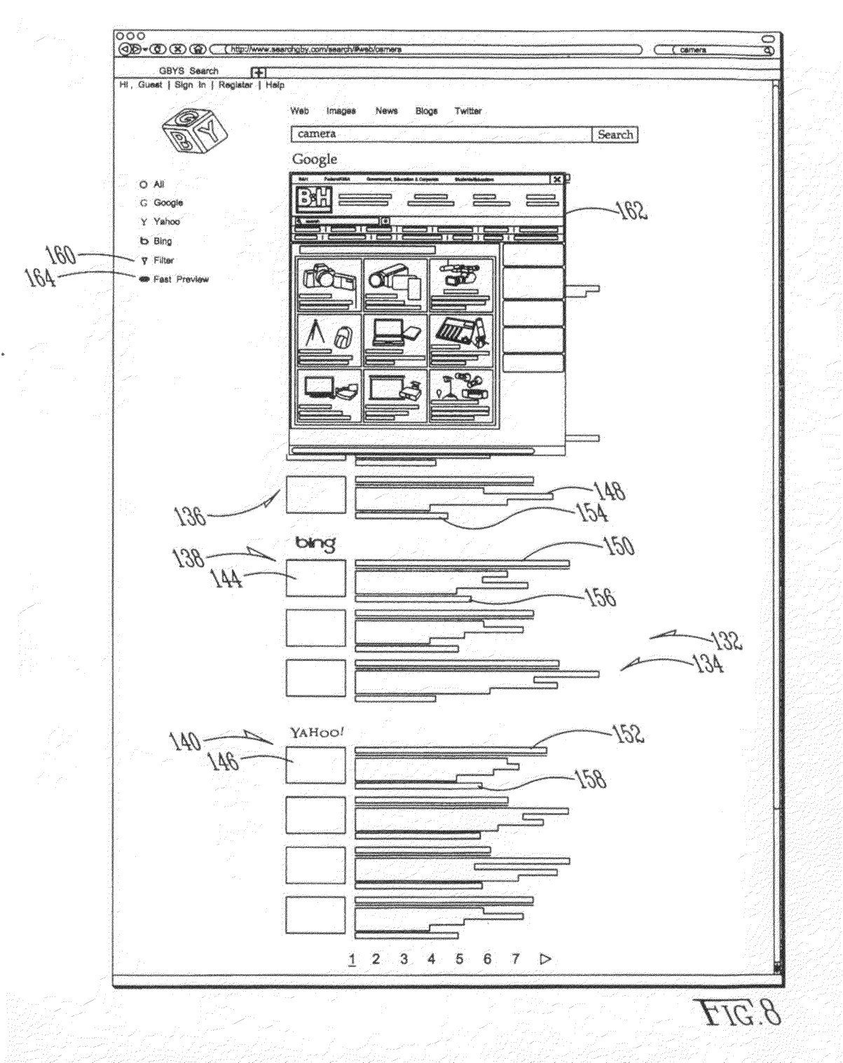

The toolbar (104) also includes a search engine page button (122). Clicking the search engine page button (122) activates the browser (16) to retrieve a search engine server webpage (124) from the master server (28). (FIGS. 1-6). The search engine server webpage (124) includes a search field (126) into which a user inputs a search query (128). The user selects the search button (130). In response, the master server (28) sends the query (128) across the Internet (30) to the search engine servers (48), (50) and (52) and retrieves the resulting search results. As shown in FIG. 7, the server results webpage (132) displays the search results (134) in groupings (136), (138) and (140) associated with the particular search engine servers (48), (50) and (52) which generated the results (134). The server results webpage (132) displays thumbnail screenshot images (142), (144) and (146) and text excerpts (148), (150) and (152) adjacent their associated website addresses (154), (156) and (158).

Also provided on the search engine server webpage (124) is a filter button (160). The user may select the filter button (160), which initiates the master server (28) to add back into the search results (134) those results which the master server (28) removed as being duplicative of a search result in another grouping (136), (138) and (140). The user may toggle the filter button (160) back and forth to add and subtract the filtered results from being displayed with the search results (134).

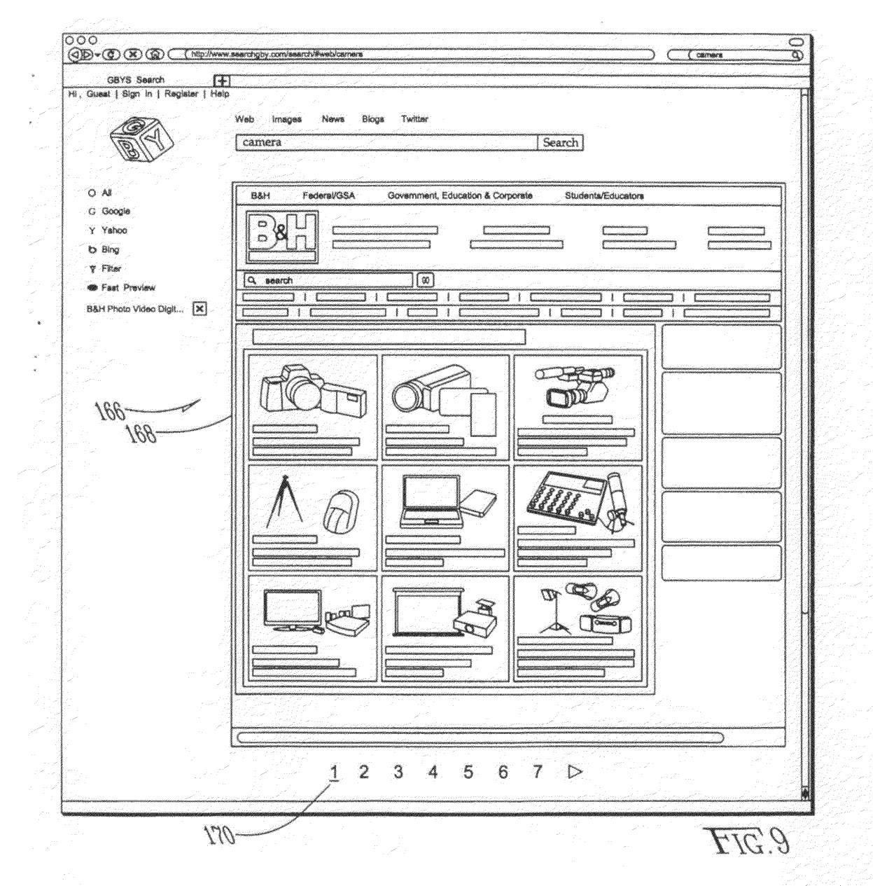

As shown in FIGS. 1, 7 and 8, when a user clicks on one of the thumbnail screenshot images (148), the browser (16) sends instructions to the master server (28) to obtain from the associated search engine server (48) a larger image (162). The user also has the option of clicking the fast preview button (164) to cause the browser (16) to generate a webpage (166) displaying large images (168) associated with the search results (134). (FIGS. 1, 6 and 8). The large images (168) are displayed without the thumbnail screenshot images (142), (144) and (146), text excerpts (148), (150) and (152) or website addresses (154), (156) and (158). Instead, each large image (168) is hyperlinked to its associated webpage. Because the webpage (166) on the master server (28) cannot act directly from the client device (12), the time required to build and display the large image slideshow (170) is greater than the time required by the add-ons (18) and (24) to build and display the large images (120) directly.

Although the invention has been described with respect to a preferred embodiment thereof, it is to be understood that it is not to be so limited since changes and modifications can be made therein which are within the full, intended scope of this invention as defined by the appended claims.

What is claimed is:

1. A system for augmenting the display of a search engine results webpage in response to a search query comprising a browser on a computing device, the browser configured to execute computer executable instructions, that when executed by the computing device, cause the browser to perform a method comprising:
(a) associating the browser with the computing device;
(b) receiving from a user inputing into the computing device, an identification of a search engine;
(c) receiving from a user inputting into the computing device, a search query;
(d) retrieving via a first script associated with the browser from the search engine, search results responsive to the query;
(e) retrieving via a second script associated with the browser from the search engine, a predetermined graphical user interface layout associated with the search engine;
(f) retrieving over a network, via a third script associated with the browser, real-time information from a server;
(g) rendering with the browser a webpage incorporating the graphical user interface layout associated with the search engine, the search results and the real-time information from the sever; and
(h) displaying the webpage to the user.

2. The system for augmenting the display of a search engine results webpage of claim 1, wherein the real-time information is a plurality of real-time images associated with the search results.

3. The system for augmenting the display of a search engine results webpage of claim 2, wherein the real-time images are displayed adjacent their associated search results.

4. The system for augmenting the display of a search engine results webpage of claim 1, wherein the real-time information is a plurality of real-time low-resolution images associated with the search results.

5. The system for augmenting the display of a search engine results webpage of claim 4, further comprising at least one high-resolution image of a screenshot displayed adjacent an associated search result.

6. The system for augmenting the display of a search engine results webpage of claim 5, wherein the high-resolution image has been scaled up from a low-resolution image.

7. The system for augmenting the display of a search engine results webpage of claim 1, wherein the real-time information is supplemental search results from a supplemental search engine.

8. The system for augmenting the display of a search engine results webpage of claim 7, wherein the real-time images are displayed adjacent their associated search results.

9. A system for augmenting the display of a search engine results webpage in response to a search query comprising a browser on a computing device, the browser configured to execute computer executable instructions, that when executed by the computing device cause the browser to perform a method comprising:
(a) associating the browser with the computing device;
(b) receiving from a user inputing into the computing device an identification of a first search engine;
(c) receiving from a user inputing into the computing device a search query;
(d) retrieving via a first script associated with the browser from the first search engine, first search results responsive to the query;
(e) retrieving via a second script associated with the browser from the first search engine, a predetermined graphical user interface layout associated with the first search engine;
(f) retrieving via a third script associated with the browser from a second search engine, second search results responsive to the query;
(g) rendering with the browser a webpage incorporating the graphical user interface layout associated with the first search engine, the first search results and the second search results; and
(h) displaying the webpage to the user.

10. The system for augmenting the display of a search engine results webpage of claim 9, further comprising retrieving and displaying on the webpage a plurality of real-time images associated with the search results.

11. The system for augmenting the display of a search engine results webpage of claim 10, wherein the real-time images are displayed adjacent their associated search results.

12. The system for augmenting the display of a search engine results webpage of claim 9, wherein the real-time information is a plurality of real-time low-resolution images associated with the search results.

13. The system for augmenting the display of a search engine results webpage of claim 12, further comprising at least one high-resolution image of a screenshot displayed adjacent an associated search result.

14. The system for augmenting the display of a search engine results webpage of claim 13, wherein the high-resolution image has been scaled up from a low-resolution image.

15. A system for displaying images in response to a search query comprising a browser on a computing device, the browser configured to execute computer executable instructions, that when executed by the computing device cause the browser to perform a method comprising:
(a) associating the browser with the computing device;
(b) receiving from a user inputting into the computing device, an identification of a first search engine;
(c) receiving from a user inputting into the computing device, a search query;
(d) retrieving via a first script associated with the browser from the first search engine, first search results responsive to the query;
(e) retrieving via a second script associated with the browser from servers associated with the search engine results, a plurality of real-time images associated with the search results;
(f) rendering with the browser a webpage incorporating the plurality of real-time images into a slideshow; and
(g) displaying the webpage to the user.

16. The system for augmenting the display of a search engine results webpage of claim 15, wherein the real-time images are high-resolution.

17. The system for augmenting the display of a search engine results webpage of claim 16, wherein the real-time images are high-resolution images which have been scaled up from a low-resolution image.

18. A system for displaying images in response to a search query comprising a browser on a computing device, the browser configured to execute computer executable instructions, that when executed by the computing device cause the browser to perform a method comprising:
(a) associating the browser with the computing device;
(b) receiving from a user inputting into the computing device, an identification of a search engine;
(c) receiving from a user inputting into the computing device, a search query;
(d) retrieving via a first script associated with the browser, a plurality of low-resolution screenshots responsive to the query;
(e) displaying the plurality of low-resolution screenshots for the user;
(f) retrieving via a second script associated with the browser, a high-resolution real-time screenshot of a low-resolution screenshot selected by the user from the plurality of low-resolution screenshots; and
(g) displaying the high-resolution screenshot for the user.

19. The system for augmenting the display of a search engine results webpage of claim 18, wherein the high-resolution real-time image has been scaled up from a low-resolution image.

20. The system for augmenting the display of a search engine results webpage of claim 1, further comprising retrieving, via a third script associated with the browser, a plurality of website addresses responsive to the query.
